(19) United States
(12) Patent Application Publication
(10) Pub. No.: US 2025/0189856 A1
(43) Pub. Date: Jun. 12, 2025

(54) ELECTROCHROMIC DEVICE FOR CAMOUFLAGE

(71) Applicant: Electronics and Telecommunications Research Institute, Daejeon (KR)

(72) Inventors: Chil Seong AH, Daejeon (KR); Ji-Young OH, Daejeon (KR); Tae-Youb KIM, Daejeon (KR); Juhee SONG, Daejeon (KR); Doo-Hee CHO, Daejeon (KR)

(73) Assignee: Electronics and Telecommunications Research Institute, Daejeon (KR)

(21) Appl. No.: 18/967,790

(22) Filed: Dec. 4, 2024

(30) Foreign Application Priority Data
Dec. 7, 2023 (KR) 10-2023-0177001
Nov. 14, 2024 (KR) 10-2024-0162290

(51) Int. Cl. G02F 1/1524; G02F 1/1523; G02F 1/153; G02F 1/155

(52) U.S. Cl. CPC G02F 1/1524; G02F 1/1525; G02F 1/1533; G02F 1/155; G02F 2001/1536

(57) ABSTRACT

Provided is an electrochromic device for camouflage and a method for manufacturing the same. The device includes a lower plate including a lower substrate and a lower color-changing layer disposed on the lower substrate, an upper plate provided on the lower plate, including an upper substrate, an upper color-changing layer disposed on the upper substrate, and an upper hole that allows a portion of the lower color-changing layer to be exposed, a protective plate provided on the upper color-changing layer, and electrolyte disposed between the upper plate and the protective plate and provided in the upper hole of the upper plate.

### CROSS-REFERENCE TO RELATED APPLICATIONS

This U.S. non-provisional patent application claims priority under 35 U.S.C. § 119 of Korean Patent Application No. 10-2023-0177001, filed on Dec. 7, 2023, No. 10-2024-0162290, filed on Nov. 14, 2024, the entire contents of which are hereby incorporated by reference.

### BACKGROUND

The present disclosure herein relates to an electrochromic device, and more particularly, to an electrochromic device for stealth camouflage that adjusts its emissivity to prevent detection by external devices.

In general, electrochromic devices may have the capability to control the transmittance of light in the visible, near-infrared (NIR), and infrared (IR) wavelength ranges. Utilizing this functionality, electrochromic devices are manufactured and sold as smart windows intended to either block or transmit light for enhancing the view in buildings or for blocking thermal infrared radiation. Th electrochromic devices can be used to make windows opaque for privacy or to block thermal infrared radiation, reducing the amount of hot sunlight entering a building during hot summer days. Additionally, electrochromic devices may be used to adjust and control the emissivity (e) of objects or living beings. Thermal imaging equipment used at night identifies specific objects or living beings by measuring the thermal temperature, which varies based on changes in the emissivity of the objects or living beings. An electrochromic device capable of controlling emissivity may change the emissivity emitted from the object or living being, allowing the object's or living being's emissivity to have a value similar to the surrounding environment. It may also conceal or camouflage the emissivity of the object or the living being to avoid detection by external thermal infrared devices.

### SUMMARY

The present disclosure provides an electrochromic device for camouflage that may easily control emissivity in a thermal infrared wavelength range.

An embodiment of the inventive concept provides an electrochromic device for camouflage, the device including: a lower plate including a lower substrate and a lower color-changing layer disposed on the lower substrate; an upper plate including an upper substrate provided on the lower plate, an upper color-changing layer disposed on the upper substrate, and an upper hole that allows a portion of the lower color-changing layer to be exposed; a protective plate provided on the upper color-changing layer; and electrolyte disposed between the upper plate and the protective plate and provided in the upper hole of the upper plate.

In an embodiment, the lower plate may further include a lower electrode disposed between the lower substrate and the lower color-changing layer.

In an embodiment, the lower color-changing layer and the lower electrode may be aligned within the upper hole.

In an embodiment, the upper plate may further include an upper electrode disposed between the upper substrate and the upper color-changing layer.

In an embodiment, the upper color-changing layer may have an upper color-changing tail provided on a sidewall of the upper electrode in the upper hole.

In an embodiment, the electrochromic device for camouflage may further include a middle plate that is disposed between the lower plate and the upper plate.

In an embodiment, the middle plate may include a middle substrate, a middle color-changing layer disposed on the middle substrate, and a middle hole that allows a portion of the lower color-changing layer to be exposed.

In an embodiment, the middle plate may further include a middle electrode that is disposed between the middle substrate and the middle color-changing layer.

In an embodiment, the middle color-changing layer may have a middle color-changing tail provided on a sidewall of the middle electrode in the middle hole.

In an embodiment, the middle hole may be smaller than the upper hole.

In an embodiment of the inventive concept, an electrochromic device for camouflage includes: a lower plate including a lower substrate, a lower electrode disposed on the lower substrate, and a lower color-changing layer disposed on the lower electrode; a middle plate including a middle substrate provided on the lower plate, a middle electrode disposed on the middle substrate, a middle color-changing layer disposed on the middle electrode, and a middle hole that allows a portion of the lower color-changing layer to be exposed; an upper plate including an upper substrate provided on the middle color-changing layer, an upper electrode disposed on the upper substrate, an upper color-changing layer disposed on the upper electrode, and an upper hole that allows a portion of the lower color-changing layer to be exposed; a protective plate provided on the upper color-changing layer; and electrolyte disposed between the upper plate and the protective plate and provided in the middle hole and the upper hole.

In an embodiment, the middle hole may have a diameter less than that of the upper hole.

In an embodiment, the upper color-changing layer may have an upper color-changing tail provided on a sidewall of the upper electrode in the upper hole.

In an embodiment, the middle color-changing layer may have a middle color-changing tail provided on a sidewall of the upper electrode in the middle hole.

In an embodiment, each of the middle electrode and the middle color-changing layer may have a ring shape.

In an embodiment of the inventive concept, a method for manufacturing an electrochromic device for camouflage includes: manufacturing a lower plate including a lower substrate, a lower electrode disposed on the lower substrate, and a lower color-changing layer disposed on the lower electrode; providing an upper plate on the lower plate, wherein the upper plate includes an upper substrate, an upper electrode disposed on the upper substrate, an upper color-changing layer disposed on the upper electrode, and an upper hole exposing a portion of the lower color-changing layer; providing electrolyte within the upper hole and on the upper color-changing layer; and providing a protective plate on the electrolyte.

In an embodiment, the method may further include providing a middle plate between the lower plate and the upper plate, the middle plate including a middle substrate, a middle electrode disposed on the middle substrate, and a middle color-changing layer disposed on the middle electrode.

In an embodiment, the middle plate may have a middle hole that allows a portion of the lower color-changing layer to be exposed.

In an embodiment, the middle hole may be smaller than the upper hole.

In an embodiment, the upper color-changing layer may include an upper color-changing tail provided on a sidewall of the upper electrode in the upper hole, and the middle color-changing layer may include a middle color-changing tail provided on a sidewall of the upper electrode in the middle hole.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a plan view illustrating one example of an electrochromic device for camouflage according to an embodiment of the inventive concept;

FIGS. 2A to 2D are cross-sectional views taken along line I-I′ of FIG. 1;

FIG. 3 is a plan view illustrating one example of an electrochromic device for camouflage according to an embodiment of the inventive concept;

FIGS. 4A to 4D are cross-sectional views taken along line II-II′ of FIG. 3;

FIGS. 5A and 5B are cross-sectional views illustrating one example of an electrochromic device for camouflage according to an embodiment of the inventive concept;

FIGS. 6A and 6B are cross-sectional views illustrating one example of an electrochromic device for camouflage according to an embodiment of the inventive concept;

FIGS. 7A to 7E are process cross-sectional views of an electrochromic device for camouflage according to an embodiment of the inventive concept;

FIG. 8 is a picture showing one example of an electrochromic device for camouflage according to an embodiment of the inventive concept;

FIG. 9 is a spectrum graph illustrating one example of prepared state, decolored state, and colored state of the electrochromic device for camouflage of FIG. 8.

FIG. 10 is a plan view illustrating one example of an electrochromic device for camouflage according to an embodiment of the inventive concept; and

FIGS. 11A to 11D are cross-sectional views taken along line III-III′ of FIG. 10.

### DETAILED DESCRIPTION

Hereinafter, preferred embodiments of the inventive concept will be described in detail with reference to the accompanying drawings. Advantages and features of the inventive concept, and implementation methods thereof will be clarified through following embodiments described with reference to the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art, and the inventive concept is only defined by the scope of the claims. Like reference numerals refer to like elements throughout.

The terms used in this specification are used only to explain embodiments while not limiting the present disclosure. In this specification, the singular forms include the plural forms as well, unless the context clearly indicates otherwise. The meaning of ‘comprises’ and/or ‘comprising’ specifies a component, an operation and/or an element does not exclude other components, operations and/or elements. Since preferred embodiments are provided below, the order of the reference numerals given in the description is not limited thereto.

Additionally, the embodiments described in this specification will be explained with reference to the cross-sectional views and/or plan views as ideal exemplary views of the present disclosure. In the drawing, the thicknesses of films and regions are exaggerated for effective description of the technical contents. Accordingly, shapes of the exemplary views may be modified according to manufacturing techniques and/or allowable errors. Therefore, the embodiments of the inventive concept are not limited to the specific shape illustrated in the exemplary views, but may include other shapes that are created according to manufacturing processes.

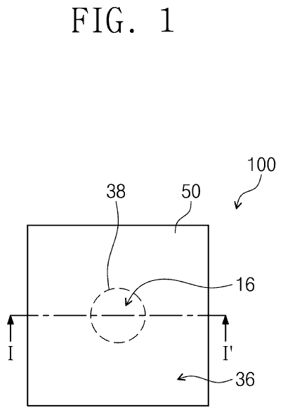

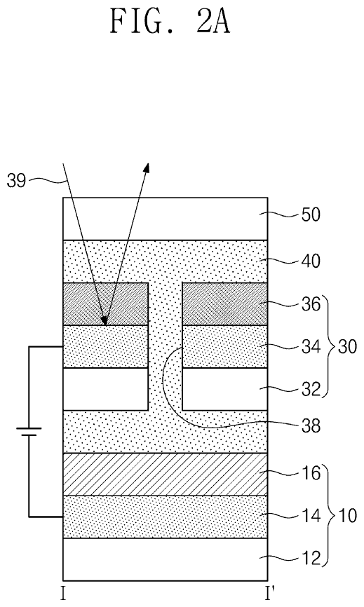

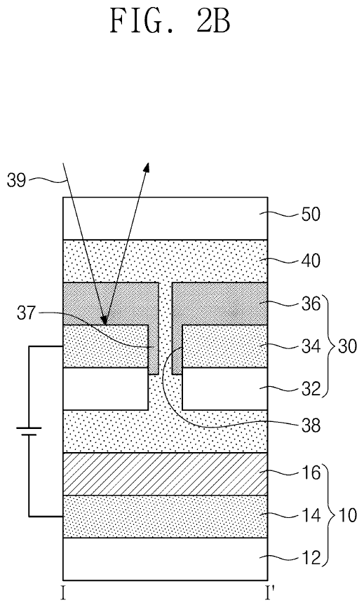

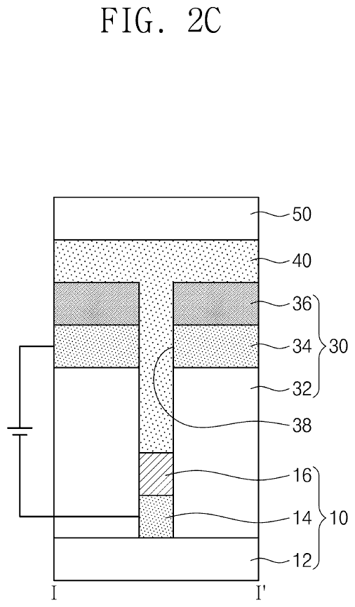

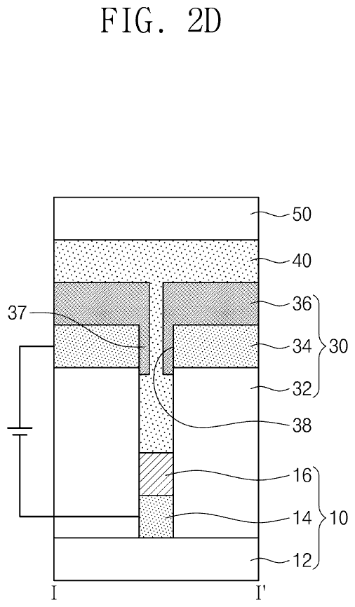

FIG. 1 illustrates one example of an electrochromic device 100 for camouflage (hereinafter, referred to as a camouflage electrochromic device 100) according to an embodiment of the inventive concept. FIGS. 2A to 2D illustrate cross-sectional views taken along line I-I′ of FIG. 1.

Referring to FIG. 1 and FIGS. 2A to 2D, the camouflage electrochromic device 100 of the inventive concept may include a lower plate 10, an upper plate 30, electrolyte 40, and a protective plate 50.

The lower plate 10 may be disposed below the upper plate 30 and the electrolyte 40. According to one example, the lower plate 10 may include a lower substrate 12, a lower electrode 14, and a lower color-changing layer 16.

The lower substrate 12 may be disposed below the lower electrode 14. For example, the lower substrate 12 may include materials such as glass or plastic. Alternatively, the lower substrate 12 may include an opaque polymer plate or a metal plate. For example, the lower substrate 12 may include PET (polyethylene terephthalate), PE (polyethylene), or FEP (fluorinated ethylene propylene), but the inventive concept is not limited thereto. The lower substrate 12 may have a thickness of about 125 μm. The lower substrate 12 may have various thicknesses, but the embodiment of the inventive concept is not limited thereto.

The lower electrode 14 may be disposed on the lower substrate 12. The lower electrode 14 may be provided on the entire surface of the lower substrate 12 or may be discretely separated. For example, the lower electrode 14 may include a transparent metal oxide such as ITO (Indium Tin Oxide) or FTO (Fluorine-doped Tin Oxide). Alternatively, the lower electrode 14 may include at least one of indium zinc oxide (IZO), indium tin oxide (ITO), fluorine-doped tin oxide (FTO), aluminum-doped zinc oxide (AZO), boron-doped zinc oxide (BZO), tungsten-doped zinc oxide (WZO), tungsten-doped tin oxide (WTO), gallium-doped zinc oxide (GZO), antimony-doped tin oxide (ATO), indium-doped indium zinc oxide (IZO), niobium (Nb)-doped titanium oxide (TiOₓ), single or multiple oxide-metal-oxide (OMO), conductive polymers, conductive organic molecules, carbon nanotubes, graphene, silver nanowires, aluminum, silver, ruthenium, gold, platinum, tin, chromium, indium, zinc, copper, rubidium, nickel, ruthenium oxide, rubidium oxide, tin oxide, indium oxide, zinc oxide, chromium oxide, or molybdenum, but the inventive concept is not limited thereto. The lower electrode 14 may have a sheet resistance of about 30Ω.

The lower color-changing layer 16 may be disposed on the lower electrode 14. The lower color-changing layer 16 may change color in response to a bias voltage between the lower electrode 14 and the upper plate 30. The lower color-changing layer 16 may include iridium oxide (IrO₂ and IrO₅) or nickel oxide (NiO). Alternatively, the lower color-changing layer 16 may include Prussian blue, viologens, phenothiazine, or conductive polymers, but the inventive concept is not limited thereto. The lower color-changing layer 16 may have a thickness of about 600 nm. The lower color-changing layer 16 may have various thicknesses, but the inventive concept is not limited thereto.

The upper plate 30 may be disposed on the lower plate 10. The upper plate 30 may have an upper hole 38. The upper hole 38 may be provided at a center of the upper plate 30. The upper hole 38 may expose a portion of a center of the lower color-changing layer 16. The upper hole 38 may have a surface area of about 20% to about 30% of a surface area of the upper plate 30 in plan view. The surface area of the upper hole 38 may vary compared to the surface area of the upper plate 30, but the inventive concept is not limited thereto. According to one example, the upper plate 30 may include an upper substrate 32, an upper electrode 34, and an upper color-changing layer 36.

The upper substrate 32 may be disposed below the upper electrode 34. The upper substrate 32 may include a transparent substrate. The upper substrate 32 may include materials such as glass, plastic, or polymer. For example, the lower substrate 32 may include PET (polyethylene terephthalate), PE (polyethylene), or FEP (fluorinated ethylene propylene), but the inventive concept is not limited thereto. The upper substrate 32 may have a thickness of about 125 nm. The upper substrate 32 may have various thicknesses, but the inventive concept is not limited thereto.

The upper electrode 34 may be disposed on the upper substrate 32. The upper electrode 34 may include a transparent electrode. The upper electrode 34 may include a material the same as that of the lower electrode 14. For example, the upper electrode 34 may include ITO or FTO. Alternatively, the upper electrode 34 may include at least one of indium zinc oxide (IZO), indium tin oxide (ITO), fluorine-doped tin oxide (FTO), aluminum-doped zinc oxide (AZO), boron-doped zinc oxide (BZO), tungsten-doped zinc oxide (WZO), tungsten-doped tin oxide (WTO), gallium-doped zinc oxide (GZO), antimony-doped tin oxide (ATO), indium-doped indium zinc oxide (IZO), niobium (Nb)-doped titanium oxide (TiOₓ), single or multiple oxide-metal-oxide (OMO), conductive polymers, conductive organic molecules, carbon nanotubes, graphene, silver nanowires, aluminum, silver, ruthenium, gold, platinum, tin, chromium, indium, zinc, copper, rubidium, nickel, ruthenium oxide, rubidium oxide, tin oxide, indium oxide, zinc oxide, chromium oxide, or molybdenum, but the inventive concept is not limited thereto. The upper electrode 34 may have a sheet resistance of about 30Ω. The lower electrode 14 is grounded, and a bias voltage may be applied to the upper electrode 34. The lower color-changing layer 16 and the upper color-changing layer 36 may change in color, that is, be colored or decolored.

The upper color-changer layer 36 may be disposed on the upper electrode 34. The upper color-changing layer 36 may adjust the emissivity in the thermal infrared wavelength range (e.g., 0.8 μm to 30 μm). For example, the upper color-changing layer 36 may include tungsten oxide (WO₃). Tungsten oxide (WO₃) may have the characteristic of variable transmittance from visible light wavelengths to infrared wavelengths. Tungsten oxide (WO₃) has the characteristic of having a variable emissivity of thermal infrared light 39. The upper color-changing layer 36 may have a surface area greater than that of the lower color-changing layer 16 exposed by the upper hole 38. That is, in cross-sectional view, the upper color-changing layer 36 may be wider than the lower color-changing layer 16. When an aperture ratio of the upper color-changing layer 36 is about 60% to 80%, an aperture ratio of the lower color-changing layer 16 exposed by the upper hole 38 may be about 20% to about 40%. The upper color-changing layer 36 may have a thickness of about 600 nm. The upper color-changing layer 36 may have various thicknesses, but the inventive concept is not limited thereto.

The electrolyte 40 may be provided on the lower plate 10 and the upper plate 30. The electrolyte 40 may be provided in the upper hole 38. The electrolyte 40 may be moved through the upper hole 38. The electrolyte (40) may color or decolor the lower color-changing layer 16 and the upper color-changing layer 36 by using ion reaction of the lower color-changing layer 16 and the upper color-changing layer 36. The electrolyte 40 may include ion-gel electrolyte or polymer electrolyte. The electrolyte 40 may have the physical properties of a liquid, gel, or solid. The electrolyte 40 may further include polymers of PVB, PMMA, or PVA to adjust its viscosity and viscoelasticity. The electrolyte 40 may include various organic or inorganic molecules including ionic liquids, LiClO₄, HCl, and other molecules including Li⁺ and H⁺ ions. The electrolyte 40 may have a thickness ranging from 10 nm to several hundred micrometers (um). The electrolyte 40 may include polymers, organic molecules, ionic liquids, solvents, or ionic molecule. The electrolyte 40, composed of a polymer, may include PEG (poly(ethylene glycol)), PMMA (Poly methyl methacrylate), PBA (Poly butyl Acrylate), PVB (Poly Vinyl Butyrate), PVA (Polyvinyl Alcohol), PEO (poly(ethylene oxide)), PPO (poly(propylene oxide)), PAN (poly acrylonitrile), PVDF (poly(vinylidene fluoride)), and at least one of PVDF-HFP (poly(vinylidene fluoride-co-hexafluoropropylene)), or block copolymer. The electrolyte 40, composed of organic molecules, solvents, and ionic liquids may include propylene carbonate (PC), butylene carbonate (BC), ethylene carbonate (EC), gamma-butyrolactone (gamma-BL), gamma-VL, NMO, dimethyl carbonate (DMC), diethyl carbonate (DEC), ethyl methyl carbonate (EMC), propyl methyl carbonate (PMC), ethyl acetate (EA), ethylene blue (EB), water (H₂O), acetone, ethanol, methylene blue (MB), morpholinium cations, imidazolium cations, quaternary ammonium cations, quaternary phosphonium cations, and at least one of Br—, Cl—, NO₃—, BF₄—, PF₆—, CH₃CO₂—, TFSI, CF₃SO₃—, N(SO₂CF₃)₂—, or CF₃WO₂—. The ionic molecule may include at least one of a lithium ion product or a hydrogen ion product. The electrolyte 40, composed of the lithium ion product may include at least one of lithium perchlorate (LiClO₄), LiBF₄, LiPF₆, LiAsF₆, LiTf (lithium triflate, LiCF₃SO₃), Lilm (lithium Imdide, Li[N(SO₂CF₃)₂]), LiBeTi (Li[N(SO₂CF₂CF₃)₂]), LiBr, Lil, and other electrolytes including lithium (Li), electrolytes including Na, or electrolytes including K. The electrolyte 40, composed of the hydrogen ion product may include at least one of hydrochloric acid (HCl), sulfuric acid (H₂SO₄), nitric acid (HNO₃), phosphoric acid (H₃PO₄), acetic acid (CH₃COOH), perchloric acid (HClO₄), or formic acid (HCOOH). Although not shown, the electrolyte 40 may include a lower electrolyte layer between the lower plate 10 and the upper plate 30, a middle electrolyte layer provided within the upper hole 38 of the upper plate 30, and an upper electrolyte layer between the upper plate 30 and the protective plate 50. The lower electrolyte layer, the middle electrolyte layer, and the upper electrolyte layer may move relative to each other to eliminate their ion concentration differences. A thickness of each of the lower electrolyte layer, middle electrolyte layer, and upper electrolyte layer may be inversely proportional to the emissivity of thermal infrared light. Each of the lower electrolyte layer, the middle electrolyte layer, and the upper electrolyte layer may have a thickness of several tens of nm to several hundred μm.

The protective plate 50 may be disposed on the electrolyte 40. The protective plate 50 may include PET (polyethylene terephthalate), PE (polyethylene), or FEP (fluorinated ethylene propylene), but the inventive concept is not limited thereto.

Referring to FIGS. 2A and 2B, the lower electrode 14 and the lower color-changing layer 16 may be disposed on the entire surface of the lower substrate 12. The electrolyte 40 may be provided between the lower color-changing layer 16 and the upper substrate 32, and also provided between the upper color-changing layer 36 and the protective plate 50. The electrolyte 40 may be provided in the upper hole 38. The upper color-changing layer 36 may control the emissivity of the thermal infrared radiation. The thermal infrared light 39 may be reflected by the upper electrode 34. The upper color-changing layer 36 may change the transmittance or absorptance (or emissivity) of the thermal infrared light 39 according to the coloration and discoloration changes of the device.

Referring to FIG. 2B and FIG. 2D, the upper color-changing layer 36 may have an upper color-changing tail 37. The upper color-changing tail 37 may be disposed on a sidewall of the upper color-changing layer 36 in the upper hole 38. The upper color-changing tail 37 may increase an aperture ratio of the upper color-changing layer 36.

Referring to FIGS. 2C and 2D, the lower electrode 14 and the lower color-changing layer 16 may be discretely separated and thus be provided in the upper hole 38. A bottom surface of the upper substrate 32 may be in contact with a top surface of the lower substrate 12. The upper color-changing layer 16 may be narrower than the upper color-changing layer 36.

Therefore, the camouflage electrochromic device 100 of the inventive concept may easily adjust the emissivity of thermal infrared light 39 by using the upper color-changing layer 36 including tungsten oxide (WO₃), which has the surface area greater than that of the lower color-changing layer 16 exposed through the upper hole 38.

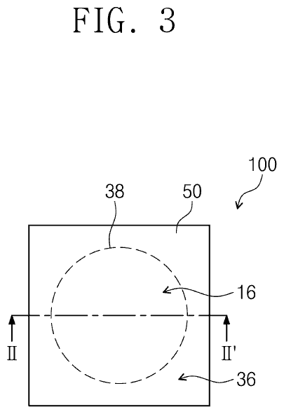

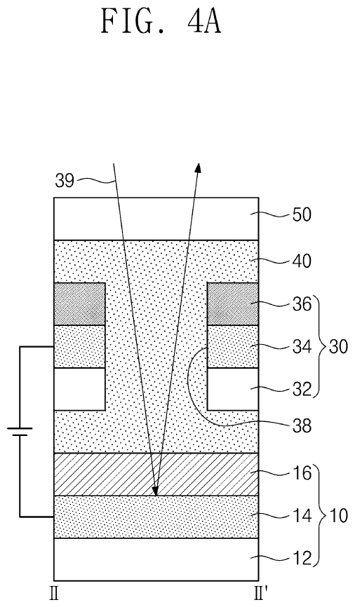

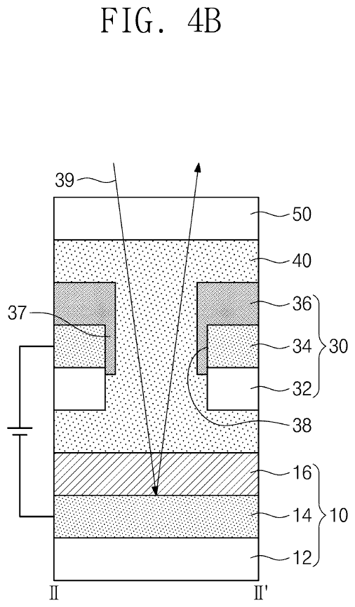

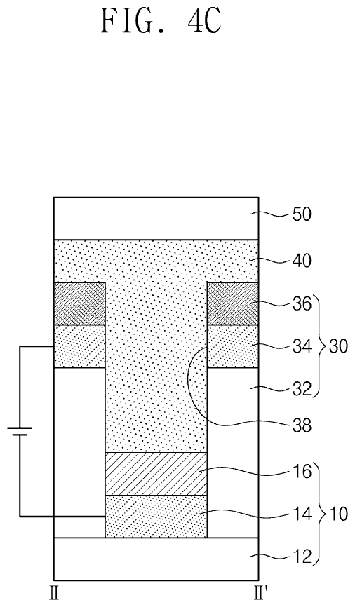

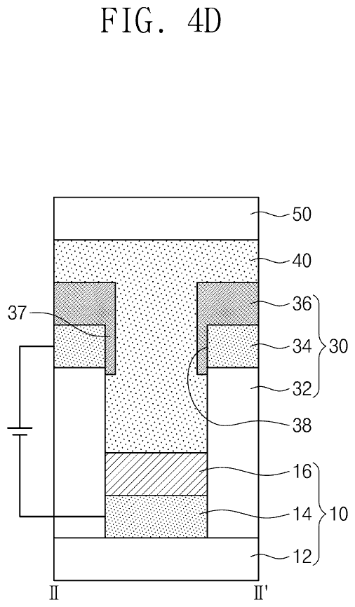

FIG. 3 illustrates one example of a camouflage electrochromic device 100 according to an embodiment of the inventive concept. FIGS. 4A to 4D are cross-sectional views taken along line II-II′ of FIG. 3.

Referring to FIGS. 3 and 4A to 4D, in the cross-sectional views, an upper hole 38 of the camouflage electrochromic device 100 of the inventive concept may allow a lower color-changing layer 16 to be exposed more widely than an upper color-changing layer 36. The lower color-changing layer 16 may include tungsten oxide (WO₃), enabling the adjustment of the emissivity of thermal infrared light 39. The upper hole 38 may expose the lower color-changing layer 16 in an aperture ratio of about 60% to about 80%. The aperture ratio of the upper color-changing layer 36 may be about 20% to 40%. The opening ratio of the upper color-changing hole 36 may differ from a surface area or aperture ratio of the upper hole 38, but the inventive concept is not limited thereto. The upper color-changing layer 36 may include iridium oxide (IrO₂ and IrO₅) or nickel oxide (NiO). Alternatively, the upper color-changing layer 36 may include Prussian blue, viologens, phenothiazine, or conductive polymers, but the inventive concept is not limited thereto.

Referring to FIGS. 4A and 4B, a lower electrode 14 and the lower color-changing layer 16 may be disposed on the entire surface of a lower substrate 12. Electrolyte 40 may be provided between the lower color-changing layer 16 and an upper substrate 32, and also provided between the upper color-changing layer 36 and a protective plate 50. In addition, the electrolyte 40 may be provided within the upper hole 38. The lower color-changing layer 16 exposed by the upper hole 38 may control the emissivity of thermal infrared radiation. The thermal infrared light 39 may be reflected by the lower electrode 14. The lower color-changing layer 16 may change the transmittance or absorptance (or emissivity) of the thermal infrared light 39 according to the coloration and discoloration changes of the device.

Referring to FIGS. 4B and 4D, the upper color-changing layer 36 may have an upper color-changing tail 37. The upper color-changing tail 37 may be disposed on a sidewall of an upper electrode 34 in the upper hole 38.

Referring to FIGS. 4C and 4D, the lower electrode 14 and the lower color-changing layer 16 may be discretely separated and thus be provided in the upper hole 38. A bottom surface of the upper substrate 32 may be in contact with a top surface of the lower substrate 12.

Therefore, the camouflage electrochromic device 100 of the inventive concept may easily adjust the emissivity of thermal infrared light 39 by using the lower color-changing layer 16 including tungsten oxide (WO₃), which is exposed wider than the upper color-changing layer 36 through the upper hole 36.

The lower substrate 12, the lower electrode 14, the upper substrate 32, the upper electrode 34, the upper color-changing layer 36, the electrolyte 40, and the protective plate 50 may have the same constitutions as in FIG. 1 and FIGS. 2A to 2D.

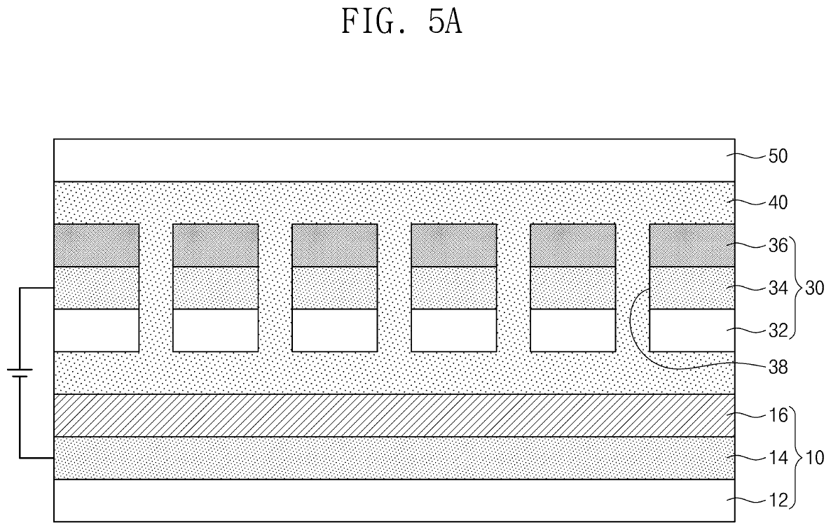

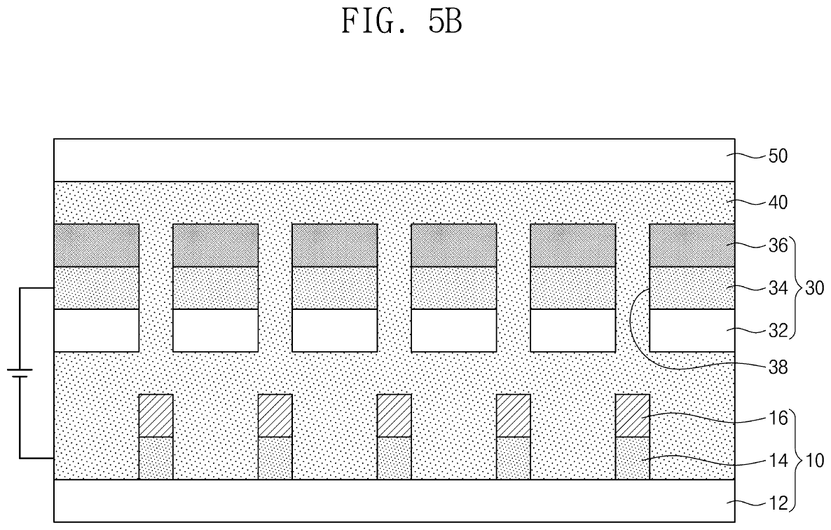

FIGS. 5A and 5B illustrate one example of a camouflage electrochromic device 100 according to an embodiment of the inventive concept.

Referring to FIGS. 5A and 5B, a lower color-changing layer 16 and an upper substrate 32 are spaced apart from each other, and an electrolyte 40 may be provided between the lower color-changing layer 16 and the upper substrate 32. For instance, the lower color-changing layer 16 and a lower electrode 14 may be disposed on the entire surface of the lower substrate 12 or may be discretely separated and aligned with an upper hole 38. The upper hole 38 may expose the lower color-changing layer 16 to a narrower or smaller extent compared to an upper color-changing layer 36. The upper color-changing layer 36 may include tungsten oxide (WO₃) and have an aperture ratio of about 60% to about 80%. The lower color-changing layer 16 has an aperture ratio of about 20% to about 40% and may be exposed by the upper hole 38.

The lower substrate 12, the lower electrode 14, the lower color-changing layer 16, the upper substrate 32, an upper electrode 34, the upper color-changing layer 36, electrolyte 40, and a protective plate 50 may have the same constitutions as in FIGS. 2A to 2D.

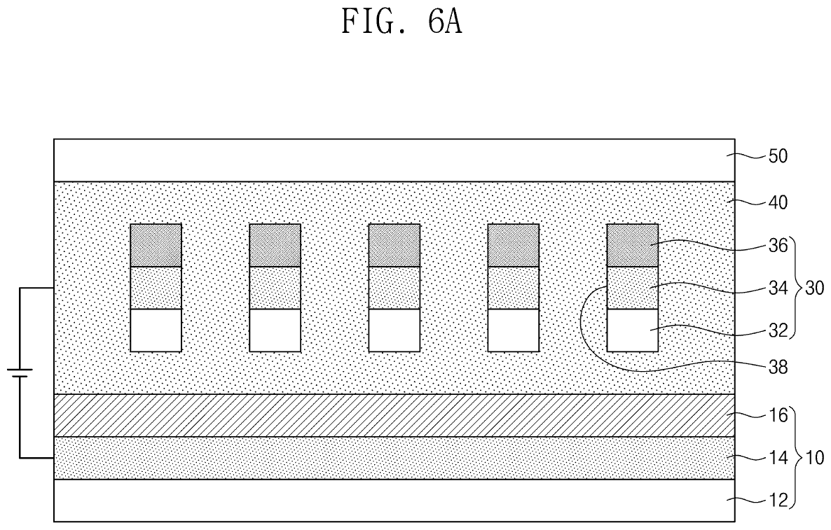

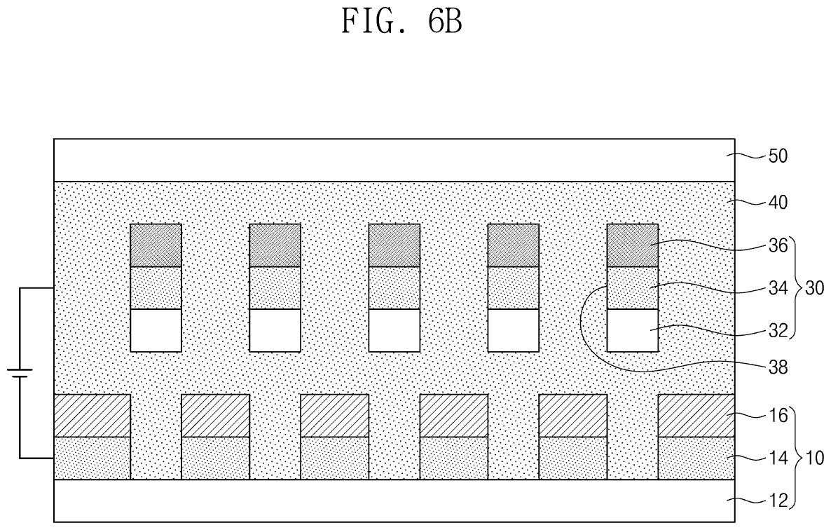

FIGS. 6A and 6B illustrate one example of a camouflage electrochromic device 100 according to an embodiment of the inventive concept.

Referring to FIGS. 6A and 6B, an upper hole 38 may expose a lower color-changing layer 16 more widely or extensively than an upper color-changing layer 36, and the lower color-changing layer 16 may include tungsten oxide (WO₃). The lower color-changing layer 16 may increase and/or control the emissivity in the wavelength range of thermal infrared. An aperture ratio of the lower color-changing layer 16 may be about 60% to about 80%. The lower color-changing layer 16 and a lower electrode 14 may be disposed on the entire surface of a lower substrate 12 or may be discretely separated and aligned with the upper hole 38.

The lower substrate 12, the lower electrode 14, the lower color-changing layer 16, an upper substrate 32, an upper electrode 34, the upper color-changing layer 36, electrolyte 40, and a protective plate 50 may have the same constitutions as in FIGS. 4A to 4D.

A method for manufacturing the camouflage electrochromic device 100 of the inventive concept configured as described above is as follows.

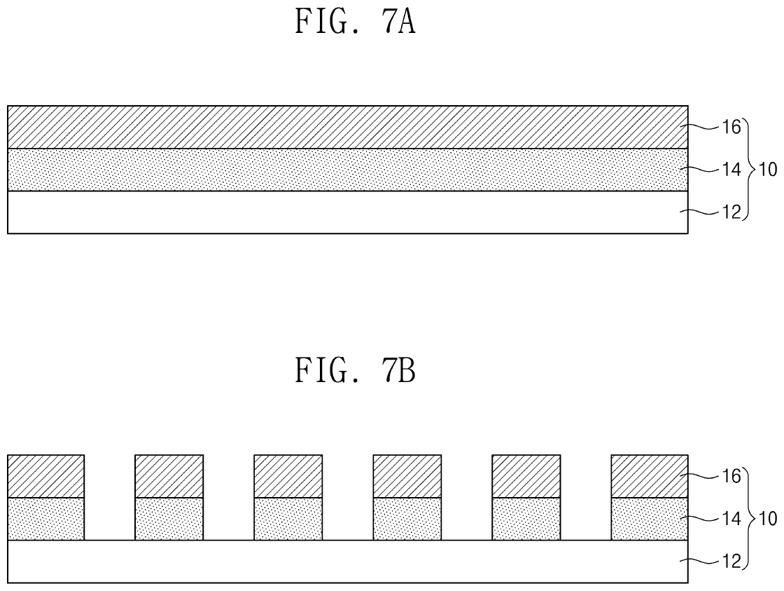

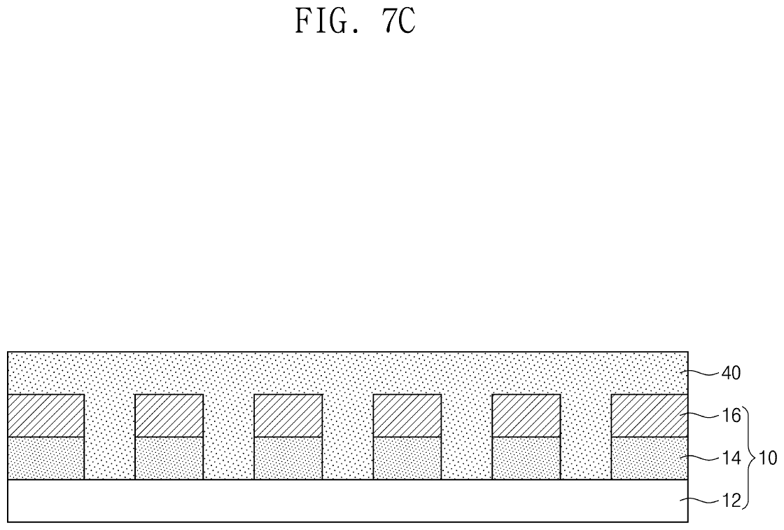

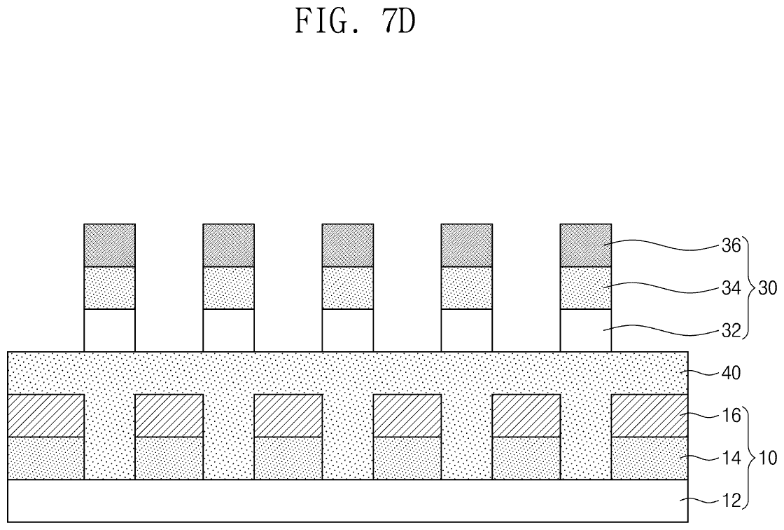

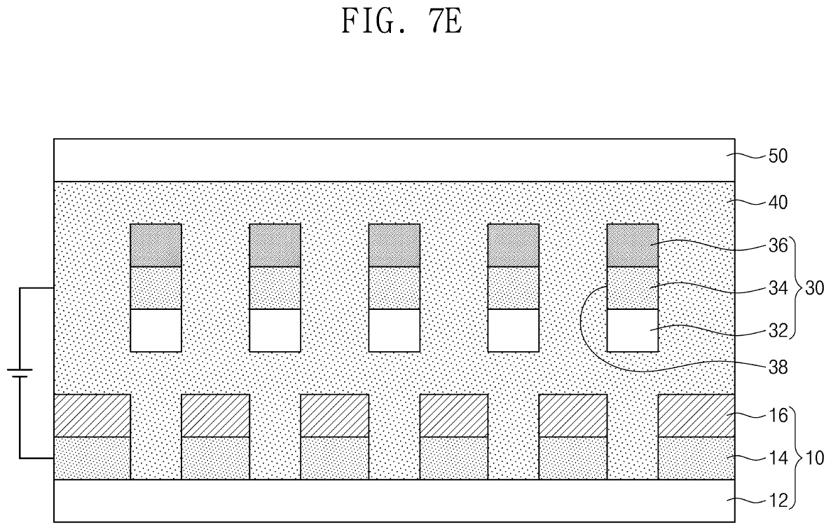

FIGS. 7A to 7E are process cross-sectional views of the camouflage electrochromic device according to an embodiment of the inventive concept.

Referring to FIGS. 7A, a lower plate 10 including a lower electrode 14 and a lower color-changing layer 16 may be formed on a lower substrate 12. The lower electrode 14 may include ITO or FTO formed by a sputtering method. The lower color-changing layer 16 may include tungsten oxide (WO₃) formed by the sputtering method. Alternatively, the lower color-changing layer 16 may include iridium oxide (IrO₂ and IrO₅) or nickel oxide (NiO) formed by the sputtering method.

Referring to FIG. 7B, a portion of each of the lower electrode 14 and the lower color-changing layer 16 may be removed. The lower electrode 14 and the lower color-changing layer 16 may be patterned by lithography, etching, and laser processes. The lithography process may include photolithography or ion beam lithography processes. The etching process may include dry etching, wet etching, or laser etching processes.

Referring to FIG. 7C, electrolyte 40 may be formed on the lower plate 10. The electrolyte 40 may include ion gel electrolyte or polymer electrolyte, formed by a dropping method, printing method, transfer method, slot-die coating method, or wet coating method.

Referring to FIG. 7D, an upper plate 30 may be provided. The upper plate 30 may be provided on the electrolyte 40. According to one example, the upper plate 30 may include an upper substrate 32, an upper electrode 34, and an upper color-changing layer 36. The upper substrate 32 may include materials like glass or plastic. The upper electrode 34 may include ITO or FTO formed by the sputtering method. When the lower color-changing layer 16 includes tungsten oxide (WO₃), the upper color-changing layer 36 may include iridium oxide (IrO₂ and IrO₅) or nickel oxide (NiO) formed by the sputtering method. When the lower color-changing layer 16 includes iridium oxide (IrO₂ and IrO₅) or nickel oxide (NiO), the upper color-changing layer 36 may include tungsten oxide (WO₃) formed by the sputtering method. The upper substrate 32, the upper electrode 34, and the upper color-changing layer 36 may have an upper hole 38. The upper hole 38 may be formed on the upper substrate 32, the upper electrode 34, and the upper color-changing layer 36 by the lithography process, the etching process, or the laser process. The upper hole 38 may expose a portion of the lower color-changing layer 16 and the electrolyte 40 on the lower color-changing layer 16.

Referring to FIG. 7E, the electrolyte 40 may be additionally formed on the upper plate (30) and within the upper hole 38. The electrolyte 40 may be formed by a dropping method, a printing method, a transfer method, a slot-die coating method, or a wet coating method.

In addition, a protective plate (50) may be provided on the electrolyte 40. The protective plate 50 may include a transparent polyethylene film.

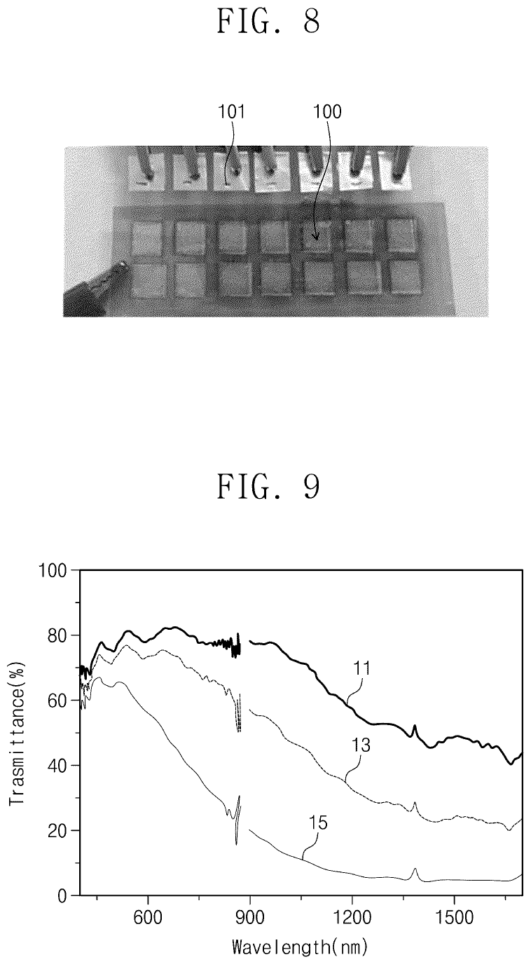

FIG. 8 is a picture showing one example of the camouflage electrochromic device 100 according to an embodiment of the inventive concept.

Referring to FIGS. 5A and 8, the camouflage electrochromic device 100 of the inventive concept may be arranged in a plurality of array forms. The lower electrode 14 is grounded, and the upper electrode 34 may be connected to a pad 101 to receive the bias voltage.

FIG. 9 is a spectrum graph illustrating one example of an as-prepared state 11, a decolored state 13, and a colored state 15 of the camouflage electrochromic device 100 in FIG. 8.

Referring to FIGS. 5A, 8, and 9, the camouflage electrochromic device 100 may change color by the bias voltage between the lower electrode 14 and the upper electrode 34. When the bias voltage is not applied between the lower electrode 14 and the upper electrode 34, the camouflage electrochromic device 100 may be in the as-prepared state 11. The camouflage electrochromic device 100 in the as-prepared state 11 may be nearly transparent.

When a bias voltage of about 2V is applied between the lower electrode 14 and the upper electrode 34, the camouflage electrochromic device 100 may be in the decolored state 13. The camouflage electrochromic device 100 in the decolored state 13 may have transmittance lower than that in the as-prepared state 11 in the visible wavelength range and the thermal infrared wavelength range.

When a bias voltage of about −1.7V is applied between the lower electrode 14 and the upper electrode 34, the camouflage electrochromic device 100 may be in the colored state 15. The colored state 15 may have transmittance lower than that in the decolored state 13. For example, in the near-infrared wavelength range of about 1500 nm, the camouflage electrochromic device 100 in the decolored state 13 may have transmittance of about 4.8%. The camouflage electrochromic device 100 in the as-prepared state 15 may have transmittance of about 24.1%.

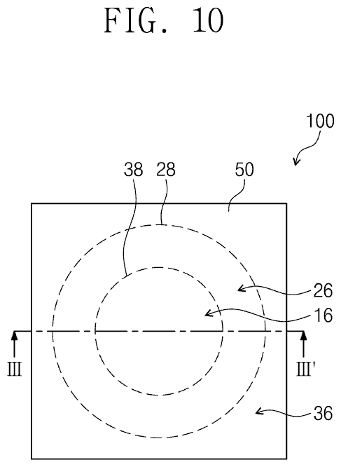

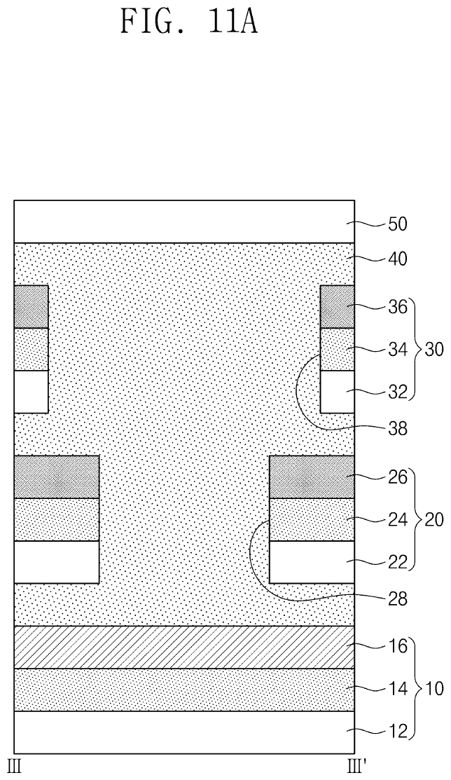

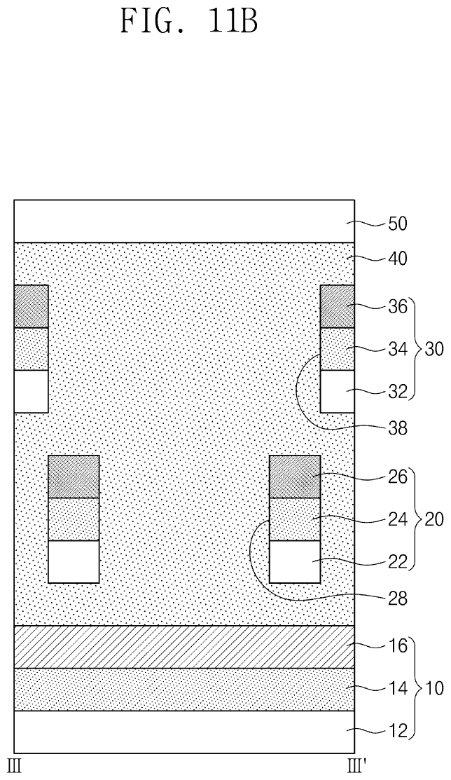

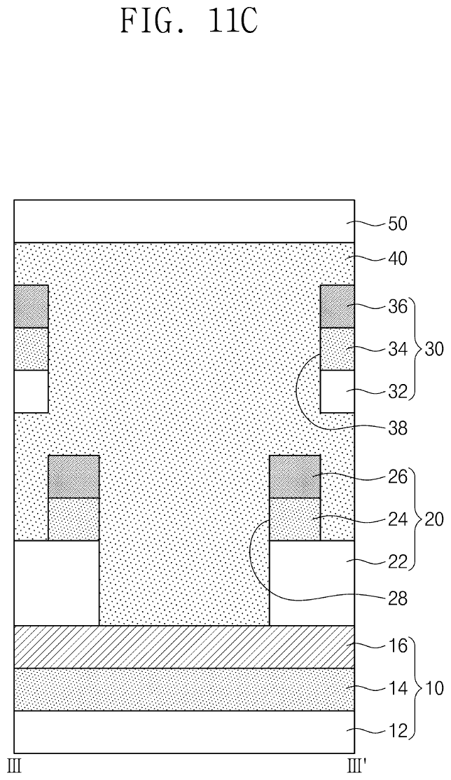

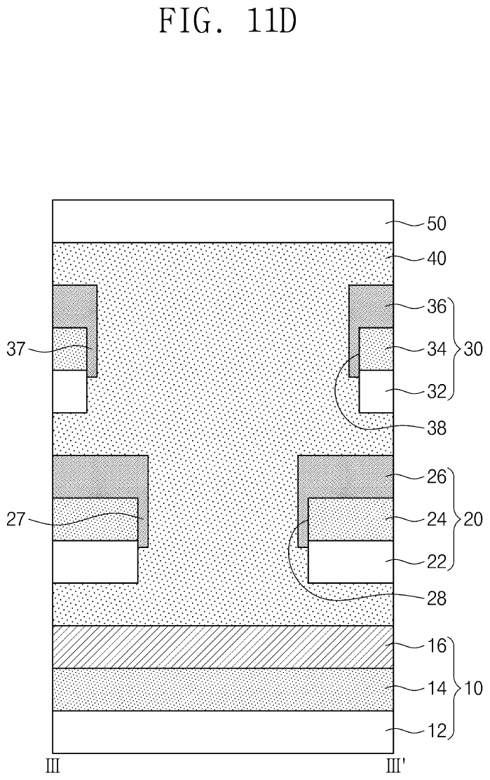

FIG. 10 illustrates one example of a camouflage electrochromic device 100 according to an embodiment of the inventive concept. FIGS. 11A to 11C are cross-sectional views taken along line III-III′ of FIG. 10.

Referring to FIG. 10 and FIGS. 11A to 11C, the camouflage electrochromic device 100 of the inventive concept may further include a middle plate 20.

The middle plate 20 may be provided between a lower plate 10 and an upper plate 30. For example, the middle plate 20 may have a middle hole 28. In addition, the middle hole 28 may be smaller than an upper hole 38. The middle plate 20 may have a ring or donut shape in plan view. According to one example, the middle plate 20 may include a middle substrate 22, a middle electrode 24, and a middle color-changing layer 26.

The middle substrate 22 may be provided below the middle electrode 24 and the middle color-changing layer 26. The middle substrate 22 may include a transparent substrate made of glass or plastic. For example, the middle substrate 22 may include PET (polyethylene terephthalate), PE (polyethylene), or FEP (fluorinated ethylene propylene), but the inventive concept is not limited thereto.

The middle electrode 24 may be disposed on the middle substrate 22. The middle electrode 24 may include ITO or FTO.

The middle color-changing layer 26 may be disposed on the middle electrode 24. The middle color-changing layer 26 may contain iridium oxide (IrO₂ and IrO₅) or nickel oxide (NiO). Additionally, the middle color-changing layer 26 may include Prussian blue or phenothiazine, but the inventive concept is not limited thereto.

The middle color-changing layer 26 may include a material different from that of each of the lower color-changing layer 16 and the upper color-changing layer 36. When the upper color-changing layer 36 includes iridium oxide (IrO₂ and IrO₅), the middle color-changing layer 26 may include nickel oxide (NiO). When the upper color-changing layer 36 include nickel oxide (NiO), the middle color-changing layer 26 may include iridium oxide (IrO₂ and IrO₅). Alternatively, the middle color-changing layer 26 and the upper color-changing layer 36 may further include Prussian blue, viologens, or conductive polymers, but the inventive concept is not limited thereto.

The lower color-changing layer 16 may include tungsten oxide (WO₃). The lower color-changing layer 16 may have an aperture ratio of about 60% to about 80%, the middle color-changing layer 26 may have an aperture ratio of about 10% to about 20%, and the upper color-changing layer 36 may have an aperture ratio of about 10% to about 20%.

Referring to FIG. 11A, the middle plate 20 may be wider than the upper plate 30 and narrower than the lower plate 10.

Referring to FIG. 11B, the middle plate 20 may have an outer diameter identical to an inner diameter of the upper hole 38.

Referring to FIG. 11C, the middle electrode 24 and the middle color-changing layer 26 of the middle plate 20 may be individually patterned on the middle substrate 22. The middle electrode 24 and the middle color-changing layer 26 may be narrower than the middle substrate 22 in plan view.

Referring to FIG. 11D, the middle color-changing layer 26 may have a middle color-changing tail 27. The middle color-changing tail 27 may be disposed on a sidewall of the middle electrode 24 in the middle hole 28. The middle color-changing tail 27 may increase effective color-changing efficiency of the middle color-changing layer 26.

A lower substrate 12, a lower electrode 14, the lower color-changing layer 16, an upper substrate 32, an upper electrode 34, the upper color-changing layer 36, electrolyte 40, and a protective plate 50 may have the same constitutions as in FIGS. 2A to 2D, and FIGS. 4A to 4D.

The electrochromic device for camouflage according to an embodiment of the inventive concept may easily control the emissivity in the thermal infrared wavelength range by using the lower and upper color-changing layers including tungsten oxide (WO₃).

The embodiments have been described in the drawings and the specification. While specific terms were used, they were not used to limit the meaning or the scope of the inventive concept described in the claims but merely used to explain an embodiment of the inventive concept. Accordingly, those skilled in the art will understand that various modifications and other equivalent embodiments are also possible. Hence, the real protective scope of the present disclosure shall be determined by the technical scope of the accompanying claims.

What is claimed is:

1. An electrochromic device for camouflage, the device comprising:
a lower plate including a lower substrate and a lower color-changing layer disposed on the lower substrate;
an upper plate including an upper substrate disposed on the lower plate, an upper color-changing layer disposed on the upper substrate, and an upper hole that allows a portion of the lower color-changing layer to be exposed;
a protective plate provided on the upper color-changing layer; and
electrolyte disposed between the upper plate and the protective plate and provided in the upper hole of the upper plate.

2. The device of claim 1, wherein the lower plate further comprises a lower electrode disposed between the lower substrate and the lower color-changing layer.

3. The device of claim 2, wherein the lower color-changing layer and the lower electrode are aligned within the upper hole.

4. The device of claim 1, wherein the upper plate further comprises an upper electrode disposed between the upper substrate and the upper color-changing layer.

5. The device of claim 4, wherein the upper color-changing layer has an upper color-changing tail provided on a sidewall of the upper electrode in the upper hole.

6. The device of claim 1, further comprising a middle plate that is disposed between the lower plate and the upper plate.

7. The device of claim 6, wherein the middle plate comprises a middle substrate, a middle color-changing layer disposed on the middle substrate, and a middle hole that allows a portion of the lower color-changing layer to be exposed.

8. The device of claim 7, wherein the middle plate further comprises a middle electrode that is disposed between the middle substrate and the middle color-changing layer.

9. The device of claim 8, wherein the middle color-changing layer has a middle color-changing tail provided on a sidewall of the middle electrode in the middle hole.

10. The device of claim 7, wherein the middle hole is smaller than the upper hole.

11. An electrochromic device for camouflage, the device comprising:
a lower plate including a lower substrate, a lower electrode disposed on the lower substrate, and a lower color-changing layer disposed on the lower electrode;
a middle plate including a middle substrate provided on the lower plate, a middle electrode disposed on the middle substrate, a middle color-changing layer disposed on the middle electrode, and a middle hole that allows a portion of the lower color-changing layer to be exposed;
an upper plate including an upper substrate provided on the middle color-changing layer, an upper electrode disposed on the upper substrate, an upper color-changing layer disposed on the upper electrode, and an upper hole that allows a portion of the lower color-changing layer to be exposed;
a protective plate provided on the upper color-changing layer; and
electrolyte disposed between the upper plate and the protective plate and provided in the middle hole and the upper hole.

12. The device of claim 11, wherein the middle hole has a diameter less than that of the upper hole.

13. The device of claim 11, wherein the upper color-changing layer has an upper color-changing tail provided on a sidewall of the upper electrode in the upper hole.

14. The device of claim 11, wherein the middle color-changing layer has a middle color-changing tail provided on a sidewall of the upper electrode in the middle hole.

15. The device of claim 11, wherein each of the middle electrode and the middle color-changing layer has a ring shape.

16. A method for manufacturing an electrochromic device for camouflage, the method comprising:
manufacturing a lower plate including a lower substrate, a lower electrode disposed on the lower substrate, and a lower color-changing layer disposed on the lower electrode;
providing an upper plate on the lower plate, wherein the upper plate includes an upper substrate, an upper electrode disposed on the upper substrate, an upper color-changing layer disposed on the upper electrode, and an upper hole exposing a portion of the lower color-changing layer;
providing electrolyte within the upper hole and on the upper color-changing layer; and
providing a protective plate on the electrolyte.

17. The method of claim 16, further comprising providing a middle plate between the lower plate and the upper plate, the middle plate including a middle substrate, a middle electrode disposed on the middle substrate, and a middle color-changing layer disposed on the middle electrode.

18. The method of claim 17, wherein the middle plate has a middle hole that allows a portion of the lower color-changing layer to be exposed.

19. The method of claim 18, wherein the middle hole is smaller than the upper hole.

20. The method of claim 18, wherein the upper color-changing layer comprises an upper color-changing tail provided on a sidewall of the upper electrode in the upper hole, and the middle color-changing layer comprises a middle color-changing tail provided on a sidewall of the upper electrode in the middle hole.
